(19) United States
(12) Patent Application Publication
(10) Pub. No.: US 2023/0273616 A1
(43) Pub. Date: Aug. 31, 2023

(54) ROUTE FOLLOWING APPARATUS, ROUTE FOLLOWING METHOD, AND COMPUTER READABLE MEDIUM

(71) Applicant: MITSUBISHI ELECTRIC CORPORATION, Tokyo (JP)

(72) Inventor: Michinori YOSHIDA, Tokyo (JP)

(73) Assignee: MITSUBISHI ELECTRIC CORPORATION, Tokyo (JP)

(21) Appl. No.: 18/195,162

(22) Filed: May 9, 2023

Related U.S. Application Data
(63) Continuation of application No. PCT/JP2021/000864, filed on Jan. 13, 2021.

(51) Int. Cl. G05D 1/02

(52) U.S. Cl. CPC G05D 1/0214; G05D 1/0217; G05D 2201/0206

(57) ABSTRACT

A route following apparatus (200) calculates a bending angle of a route at a reference waypoint, the reference waypoint being an Xth waypoint from a position of a mobility vehicle (110) based on route data that indicates a plurality of waypoints. In a case where the bending angle is less than an angle threshold, the route following apparatus determines a position that is a reference distance ahead of the position of the mobility vehicle as a target position that is to be a next destination of the mobility vehicle. In a case where the bending angle is more than the angle threshold, the route following apparatus determines a position that is a shortened distance ahead of the position of the mobility vehicle as the target position, the shortened distance being shorter than the reference distance.

### CROSS REFERENCE TO RELATED APPLICATIONS

This application is a Continuation of PCT International Application No. PCT/JP2021/000864, filed on Jan. 13, 2021, which is hereby expressly incorporated by reference into the present application.

### TECHNICAL FIELD

The present disclosure relates to route following of a mobility vehicle.

### BACKGROUND ART

A mobility vehicle such as an electric wheelchair or a mobility scooter for seniors is desired to travel by causing the mobility vehicle to follow a route set in advance.

Patent Literature 1 discloses a method to cause a mobility vehicle to travel by following a route.

### CITATION LIST

### Patent Literature

Patent Literature 1: WO 2012/164691

### SUMMARY OF INVENTION

### Technical Problem

The present disclosure aims, in a method different from a method of Patent Literature 1, to cause a mobility vehicle to travel by following a route.

### Solution to Problem

A route following apparatus according to the present disclosure includes:
a bending angle calculation unit to calculate a bending angle of a route at a reference waypoint, the reference waypoint being (the number of reference points)th waypoint toward a goal point from a position of a mobility vehicle, based on route data that indicates a plurality of waypoints positioned on the route to the goal point;
a bending angle verification unit to compare the bending angle with an angle threshold; and
a target position determination unit to determine a position that is a reference distance ahead of the position of the mobility vehicle as a target position that is to be a next destination of the mobility vehicle in a case where the bending angle is less than the angle threshold, and to determine a position that is a shortened distance ahead of the position of the mobility vehicle as the target position, the shortened distance being shorter than the reference distance, in a case where the bending angle is more than the angle threshold.

### Advantageous Effects of Invention

According to the present disclosure, causing a mobility vehicle to travel by following a route based on a bending angle of the route will be possible.

### BRIEF DESCRIPTION OF DRAWINGS

FIG. 1 is a configuration diagram of a mobility system 100 in Embodiment 1.

FIG. 2 is a configuration diagram of a route following apparatus 200 in Embodiment 1.

FIG. 3 is a flowchart of a route following method in Embodiment 1.

FIG. 4 is a flowchart of step S120 in Embodiment 1.

FIG. 5 is a flowchart of step S140 in Embodiment 1.

FIG. 6 is a flowchart of step S150 in Embodiment 1.

FIG. 7 is an explanatory diagram of an effect in Embodiment 1.

FIG. 8 is a configuration diagram of a route following apparatus 200 in Embodiment 2.

FIG. 9 is a flowchart of a route following method in Embodiment 2.

FIG. 10 is a flowchart of step S240 in Embodiment 2.

FIG. 11 is a diagram illustrating an example of a midpoint and a risk area in Embodiment 2.

FIG. 12 is a flowchart of step S250 in Embodiment 2.

FIG. 13 is an explanatory diagram of an effect in Embodiment 2.

FIG. 14 is a configuration diagram of a route following apparatus 200 in Embodiment 3.

FIG. 15 is a flowchart of a route following method in Embodiment 3.

FIG. 16 is a flowchart of step S340 in Embodiment 3.

FIG. 17 is a diagram illustrating an example of a representative point and a detour route in Embodiment 3.

FIG. 18 is a flowchart of step S350 in Embodiment 3.

FIG. 19 is an explanatory diagram of an effect in Embodiment 3.

FIG. 20 is a hardware configuration diagram of the route following apparatus 200 in the embodiments.

### DESCRIPTION OF EMBODIMENTS

In the embodiments and in the drawings, the same reference signs are added to the same elements or corresponding elements. Description of elements having the same reference signs added as the elements described will be suitably omitted or simplified. Arrows in the drawings mainly indicate flows of data or flows of processes.

### Embodiment 1

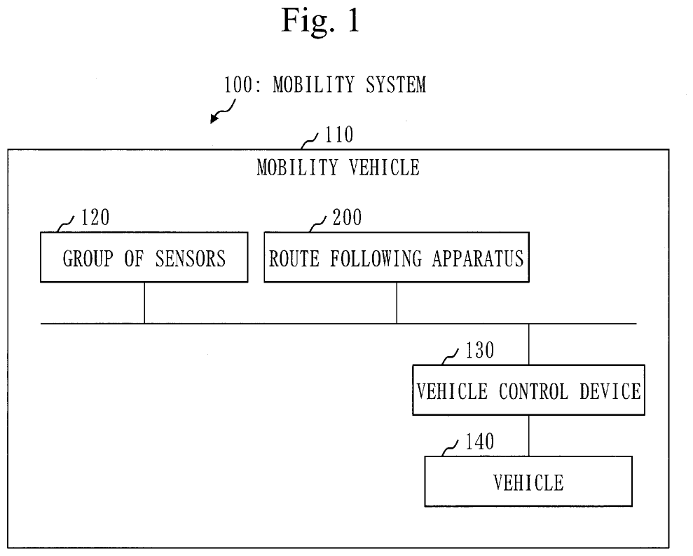

A mobility system 100 will be described based on FIG. 1 to FIG. 7.

### Description of Configuration

A configuration of the mobility system 100 will be described based on FIG. 1.

The mobility system 100 includes a mobility vehicle 110.

The mobility vehicle 110 is a vehicle that can cause a vehicle body to turn on the spot, and is also called a personal mobility vehicle. A specific example of the mobility vehicle 110 is an electric wheelchair or a mobility scooter for seniors.

The mobility vehicle 110 includes a group of sensors 120, a route following apparatus 200, a vehicle control device 130, and a vehicle 140. These pieces of hardware are connected to each other by signal lines.

The group of sensors 120 is one or more sensors including an object detection sensor, a positioning sensor, and the like.

The object detection sensor is a sensor to detect an object that exists around the mobility vehicle 110. Specific examples of the object detection sensor are a camera and a laser sensor.

The positioning sensor is a sensor to measure a position of the mobility vehicle 110. Specific examples of the positioning sensor are a receiver and an inertial measurement device of a satellite positioning system.

The route following apparatus 200 determines a target position of the mobility vehicle 110 and a travel speed of the mobility vehicle 110.

The target position is a position that is to be a next destination of the mobility vehicle 110, and is determined repeatedly until the mobility vehicle 110 arrives at a goal point.

The travel speed is a speed of the mobility vehicle 110 until the mobility vehicle 110 arrives at the target position.

The vehicle control device 130 automatically controls the vehicle 140 to move the mobility vehicle 110 to the target position.

The vehicle 140 is a body of the mobility vehicle 110, and includes a speed control device, a posture control device, and the like.

The group of sensors 120, however, does not have to be provided on the mobility vehicle 110, and may be provided, for example, on various places on a road.

The route following apparatus 200 may be provided externally of the mobility vehicle 110. In such a case, the mobility vehicle 110 includes a communication device to communicate with the route following apparatus 200.

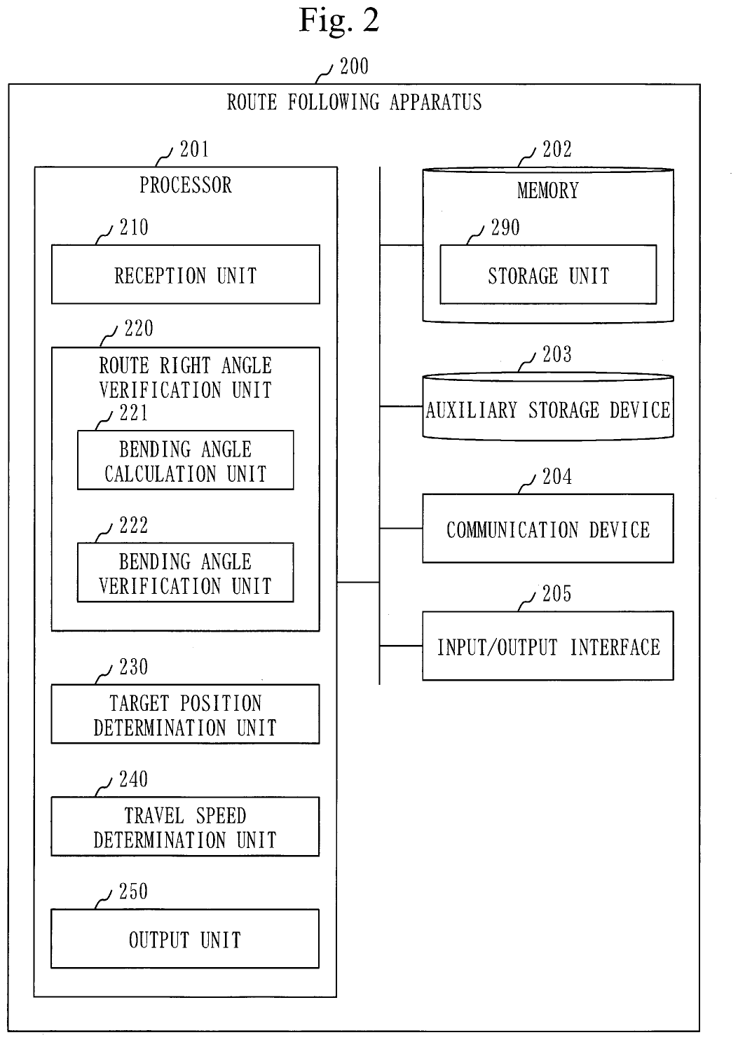

A configuration of the route following apparatus 200 will be described based on FIG. 2.

The route following apparatus 200 is a computer that includes hardware such as a processor 201, a memory 202, an auxiliary storage device 203, a communication device 204, and an input/output interface 205. These pieces of hardware are connected to each other by signal lines.

The processor 201 is an IC that performs a calculation process and controls other hardware. For example, the processor 201 is a CPU, a DSP, or a GPU.

IC is an abbreviated name for Integrated Circuit.

CPU is an abbreviated name for Central Processing Unit.

DSP is an abbreviated name for Digital Signal Processor.

GPU is an abbreviated name for Graphics Processing Unit.

The memory 202 is a volatile or a non-volatile storage device. The memory 202 is also called a main storage device or a main memory. For example, the memory 202 is a RAM. Data stored in the memory 202 is saved in the auxiliary storage device 203 as necessary.

RAM is an abbreviated name for Random Access Memory.

The auxiliary storage device 203 is a non-volatile storage device. For example, the auxiliary storage device 203 is a ROM, an HDD, or a flash memory. Data stored in the auxiliary storage device 203 is loaded into the memory 202 as necessary.

ROM is an abbreviated name for Read Only Memory.

HDD is an abbreviated name for Hard Disk Drive.

The communication device 204 is a receiver and a transmitter. For example, the communication device 204 is a communication chip or an NIC. Communication with the route following apparatus 200 is performed using the communication device 204.

NIC is an abbreviated name for Network Interface Card.

The input/output interface 205 is a port to which an input device and an output device are connected. For example, the input/output interface 205 is a USB terminal. Input to and output from the route following apparatus 200 is performed using the input/output interface 205 or the communication device 204.

USB is an abbreviated name for Universal Serial Bus.

The route following apparatus 200 includes elements such as a reception unit 210, a route right angle verification unit 220, a target position determination unit 230, a travel speed determination unit 240, and an output unit 250. The route right angle verification unit 220 includes elements such as a bending angle calculation unit 221 and a bending angle verification unit 222. These elements are realized by software.

A route following program for causing a computer to function as the reception unit 210, the route right angle verification unit 220, the target position determination unit 230, the travel speed determination unit 240, and the output unit 250 is stored in the auxiliary storage device 203. The route following program is loaded into the memory 202 and executed by the processor 201.

The auxiliary storage device 203 further stores an OS. At least a part of the OS is loaded into the memory 202 and executed by the processor 201.

The processor 201 executes the route following program while executing the OS.

OS is an abbreviated name for Operating System.

Inputted/outputted data of the route following program is stored in a storage unit 290.

The memory 202 functions as the storage unit 290. A storage device such as the auxiliary storage device 203, a register in the processor 201, a cache memory in the processor 201, and the like, however, may function as the storage unit 290 instead of the memory 202 or with the memory 202.

The route following apparatus 200 may include a plurality of processors that replace the processor 201.

The route following program can be computer-readably recorded (stored) in a non-volatile recording medium such as an optical disc, the flash memory, or the like.

### Description of Operation

A procedure of operation of the route following apparatus 200 is equivalent to a route following method. The procedure of the operation of the route following apparatus 200 is equivalent to a procedure of a process by the route following program.

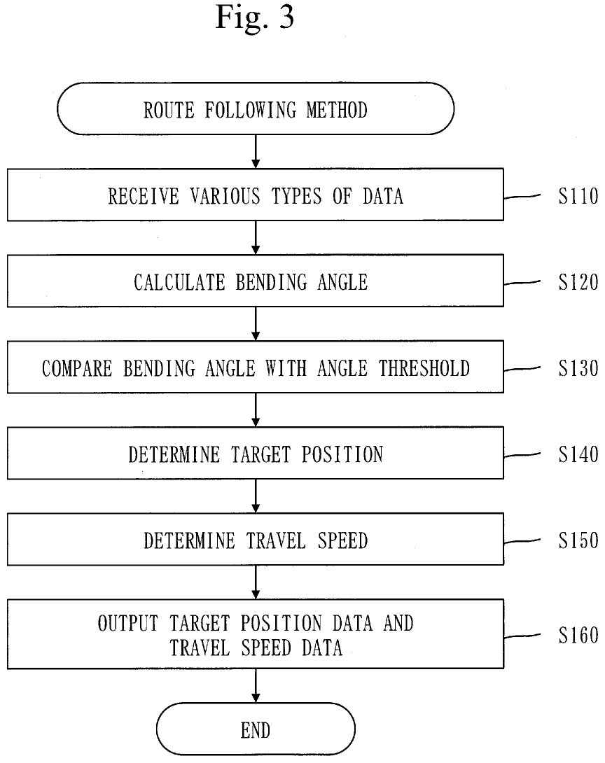

The route following method will be described based on FIG. 3.

In step S110, the reception unit 210 receives various types of data, and stores the various types of data in the storage unit 290.

Specific examples of the various types of data are route data, position data, and the like.

The route data indicates a plurality of waypoints positioned on a route from a starting point to the goal point. The route from the starting point to the goal point is called “long-term route”.

The position data indicates the position of the mobility vehicle 110 (current position). The position of the mobility vehicle 110 is measured by the positioning sensor of the group of sensors 120.

In step S120, the bending angle calculation unit 221 calculates a bending angle of the route at a reference waypoint based on the route data.

The reference waypoint is (the number of reference points)th waypoint toward the goal point from the position of the mobility vehicle 110. The number of reference points can be determined beforehand.

The bending angle represents a size of a bend in the route. The bending angle at the reference waypoint is equivalent to a turning angle of the mobility vehicle 110 at a time of the mobility vehicle 110 passing the reference waypoint.

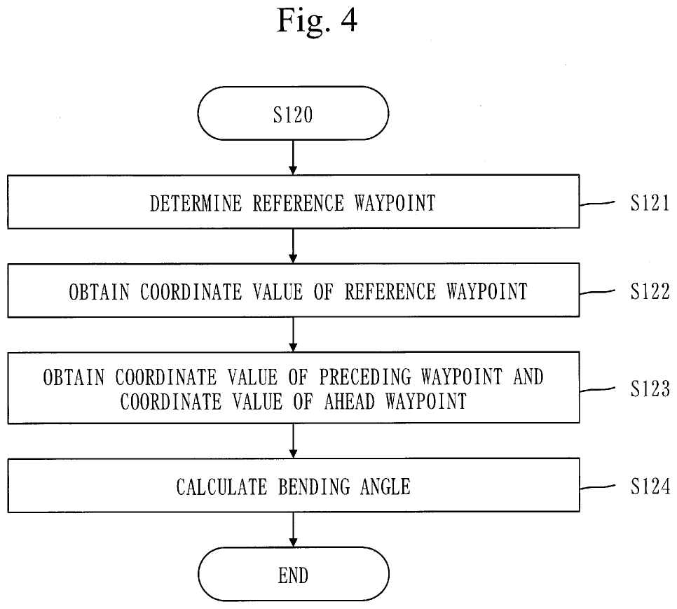

A procedure of step S120 will be described based on FIG. 4.

In step S121, the bending angle calculation unit 221 determines the reference waypoint from the plurality of waypoints indicated in the route data based on the position of the mobility vehicle 110.

Specifically, the bending angle calculation unit 221 determines an Xth waypoint counting from the position of the mobility vehicle 110 as the reference waypoint.

In step S122, the bending angle calculation unit 221 obtains a coordinate value of the reference waypoint from the route data.

In step S123, the bending angle calculation unit 221 obtains a coordinate value of a preceding waypoint and a coordinate value of an ahead waypoint from the route data.

The preceding waypoint is a waypoint positioned preceding the reference waypoint. Specifically, the preceding waypoint is an (X−1)th waypoint counting from the position of the mobility vehicle 110.

The ahead waypoint is a waypoint positioned ahead of the reference waypoint. Specifically, the ahead waypoint is an (X+1)th waypoint counting from the position of the mobility vehicle 110.

In step S124, the bending angle calculation unit 221 calculates the bending angle of the route at the reference waypoint based on the coordinate value of the reference waypoint, the coordinate value of the preceding waypoint, and the coordinate value of the ahead waypoint.

For example, the bending angle calculation unit 221 calculates a vector from the preceding waypoint to the reference waypoint, and a vector from the reference waypoint to the ahead waypoint. Then the bending angle calculation unit 221 calculates an angle that the two vectors form. The angle that is calculated is the bending angle.

Bending angle θ can be represented by formula (1).
“Wᵢ” represents a position of the reference waypoint.
“Wᵢ₋₁” represents a position of the preceding waypoint.
“Wᵢ₊₁” represents a position of the ahead waypoint.

$$[ Numerical Formula 1 ]$$

$$θ = {cos}^{- 1} ( \frac{{w}_{i + 1} - {w}_{i} / \vert {w}_{i + 1} - {w}_{i} \vert}{{w}_{i} - {w}_{i - 1} / \vert {w}_{i} - {w}_{i - 1} \vert} ) \qquad ( 1 )$$

Returning to FIG. 3, the description will continue from step S130.

In step S130, the bending angle verification unit 222 compares the bending angle with an angle threshold. The angle threshold is an angle that is determined beforehand. Specifically, the angle threshold is an angle that is close to 90 degrees.

In step S140, the target position determination unit 230 determines the target position based on a comparison result between the bending angle and the angle threshold.

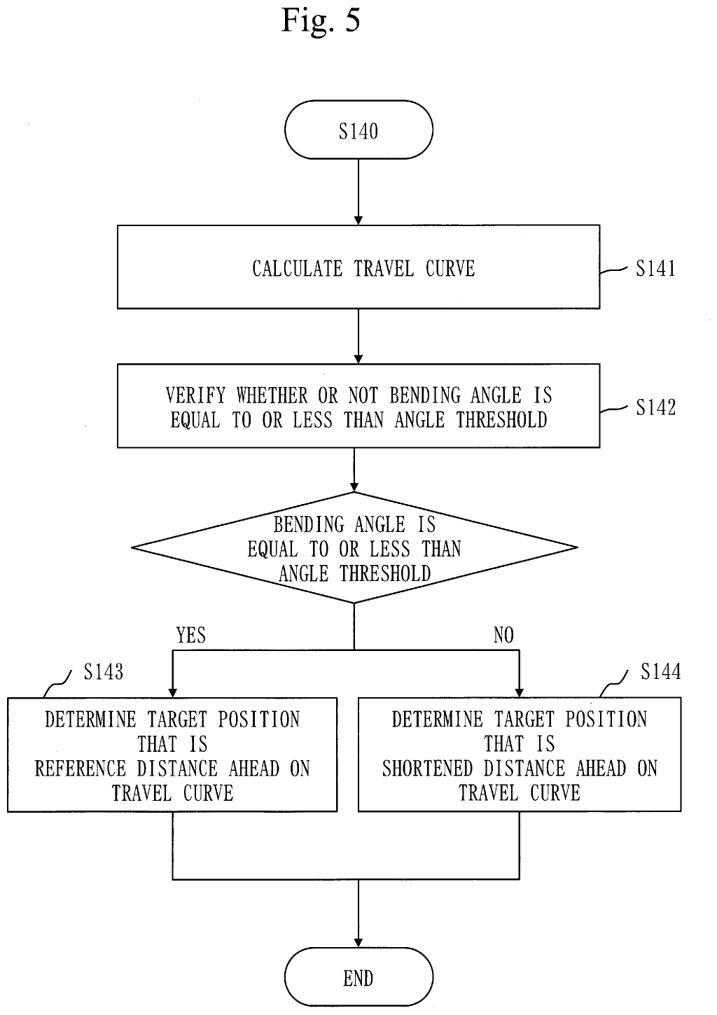

A procedure of step S140 will be described based on FIG. 5.

In step S141, the target position determination unit 230 calculates a travel curve of the mobility vehicle 110.

The travel curve is a curve along the route before and after the reference waypoint, and represents a path of the mobility vehicle 110 at a time of the mobility vehicle 110 passing along the route that is before and after the reference waypoint.

Specifically, the target position determination unit 230 calculates the travel curve based on the position of the mobility vehicle 110, the coordinate value of the preceding waypoint, the coordinate value of the reference waypoint, and the coordinate value of the ahead waypoint. For example, the travel curve is an arc with the position of the mobility vehicle 110 as a start point, the ahead waypoint as an end point, and having a specific curvature. A calculation method of the travel curve can be any method.

In step S142, the target position determination unit 230 verifies whether or not the bending angle is equal to or less than the angle threshold based on the comparison result of step S130.

In a case where the bending angle is equal to or less than the angle threshold, the process proceeds to step S143.

In a case where the bending angle is more than the angle threshold, the process proceeds to step S144.

In a case where the bending angle is equal to the angle threshold, however, the process may be made so that the process proceeds to step S144.

In step S143, the target position determination unit 230 determines the target position from the travel curve. Specifically, the target position determination unit 230 determines a position that is a reference distance ahead of the position of the mobility vehicle 110 as the target position.

The reference distance is a distance that is determined beforehand.

In step S144, the target position determination unit 230 determines the target position from the travel curve. Specifically, the target position determination unit 230 determines a position that is a shortened distance ahead of the position of the mobility vehicle 110 as the target position.

The shortened distance is a distance shorter than the reference distance and is determined beforehand. For example, in a case where the reference distance is one meter, the shortened distance is half the reference distance, 0.5 meters.

Returning to FIG. 3, the description will continue from step S150.

In step S150, the travel speed determination unit 240 determines the travel speed based on the comparison result between the bending angle and the angle threshold.

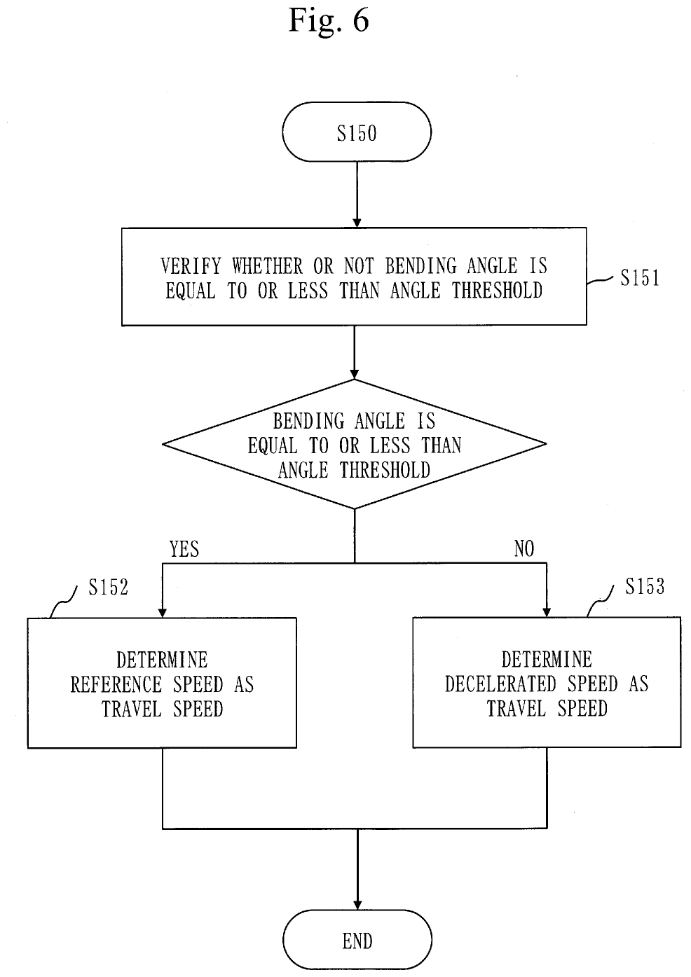

A procedure of step S150 will be described based on FIG. 6.

In step S151, the travel speed determination unit 240 verifies whether or not the bending angle is equal to or less than the angle threshold based on the comparison result of step S130.

In a case where the bending angle is equal to or less than the angle threshold, the process proceeds to step S152.

In a case where the bending angle is more than the angle threshold, the process proceeds to step S153.

In a case where the bending angle is equal to the angle threshold, however, the process may be made so that the process proceeds to step S153.

In step S152, the travel speed determination unit 240 determines a reference speed as the travel speed.

The reference speed is a speed that is determined beforehand.

In step S153, the travel speed determination unit 240 determines a decelerated speed as the travel speed.

The decelerated speed is a speed slower than the reference speed and is determined beforehand. For example, the decelerated speed is 0.2 times the reference speed.

Step S160 will be described returning to FIG. 3.

In step S160, the output unit 250 outputs target position data and travel speed data to the vehicle control device 130.

The target position data indicates the target position that is determined in step S140.

The travel speed data indicates the travel speed that is determined in step S150.

The vehicle control device 130, by controlling the vehicle 140, moves the mobility vehicle 110 to the target position determined at the travel speed determined.

Step S110 to step S160 are executed repeatedly. In step S110, however, it is possible that receiving of the route data is done only a first time.

### Effects of Embodiment 1

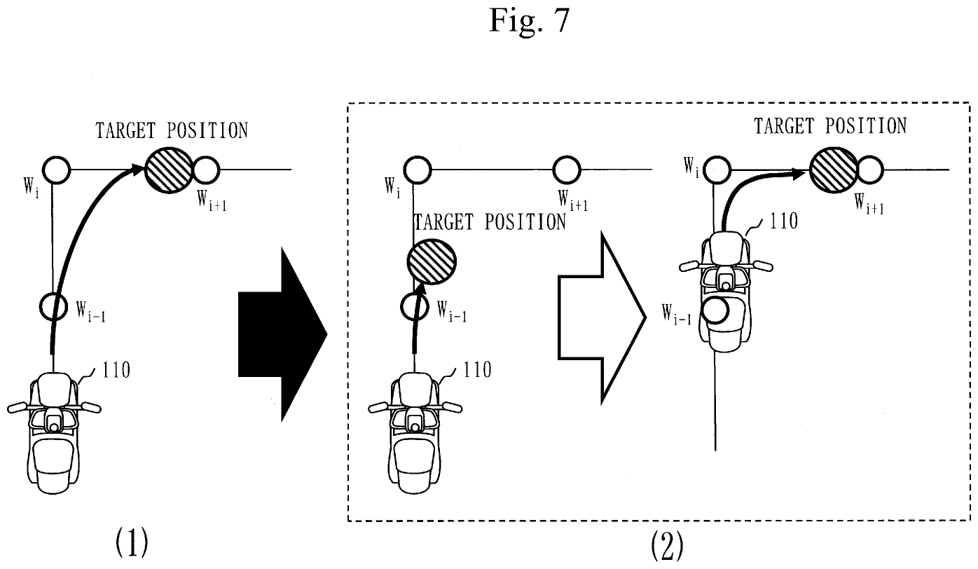

Effects of Embodiment 1 will be described based on FIG. 7. A white circle represents the waypoint, and a hatched circle represents the target position. A solid line that links the plurality of waypoints represents the long-term route. An arrowed line represents a travel path of the mobility vehicle 110.

(1) The bending angle at the reference waypoint (Wᵢ) of the route is a right angle. Consequently, the bending angle is large. In this case, when the target position is not near, the mobility vehicle 110 is to travel a curve that is significantly deviated inward from the route.

(2) On the other hand, in Embodiment 1, the target position is changed to a nearer position in a case where the bending angle is large. As a result, the mobility vehicle 110 is to travel a curve that is near the route. In other words, it becomes possible to cause the mobility vehicle 110 to travel while causing the mobility vehicle 110 to follow the route. In Embodiment 1, the travel speed is changed to a slow speed in a case where the bending angle is large. As a result, since propulsive force of the mobility vehicle 110 is decreased, the mobility vehicle 110 moving in a lateral direction is reduced, and riding comfort of the mobility vehicle 110 is increased.

In the method of Patent Literature 1, since the mobility vehicle travels in a zigzag in case where the route is in a zigzag, riding comfort of the mobility vehicle is reduced.

On the other hand, in Embodiment 1, it will be possible to cause the mobility vehicle 110 to travel on a smooth curve without causing the mobility vehicle 110 to travel in a zigzag even in a case where the long-term route is a zigzag route. Consequently, the riding comfort of the mobility vehicle 110 is increased.

### Embodiment 2

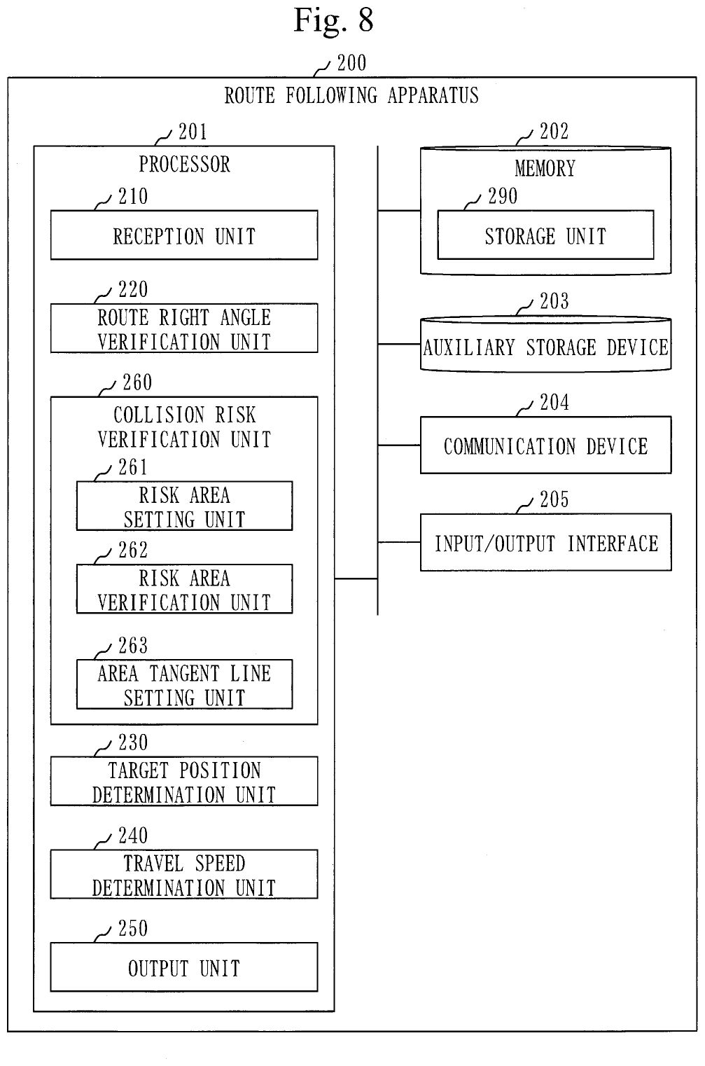

With regard to a form to avoid a collision with an object that exists around the mobility vehicle 110, mainly differing points from Embodiment 1 will be described based on FIG. 8 to FIG. 13.

### Description of Configuration

A configuration of the mobility system 100 is a same as the configuration in Embodiment 1 (refer to FIG. 1).

A configuration of the route following apparatus 200 will be described based on FIG. 8.

The route following apparatus 200 further includes a collision risk verification unit 260. The collision risk verification unit 260 includes such elements as a risk area setting unit 261, a risk area verification unit 262, and an area tangent line setting unit 263.

The route following program further causes the computer to function as the collision risk verification unit 260.

### Description of Operation

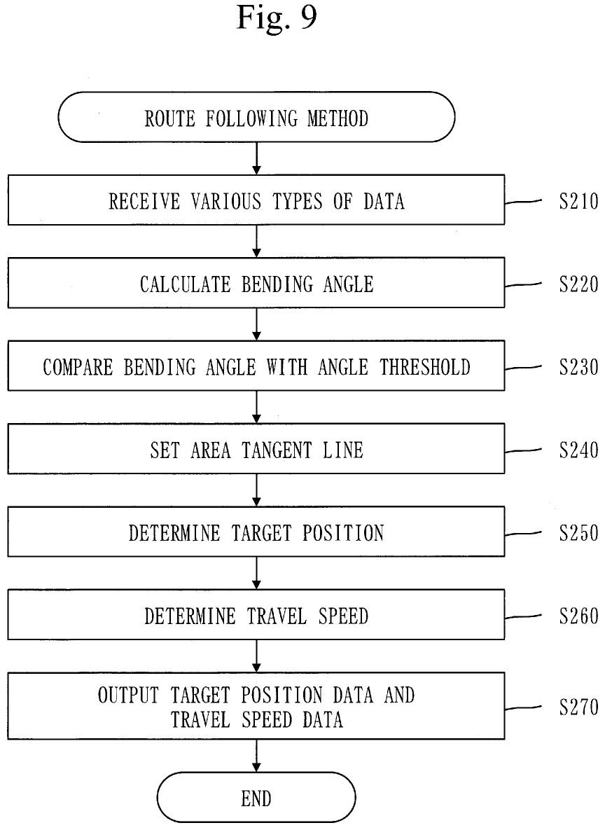

The route following method will be described based on FIG. 9.

In step S210, the reception unit 210 receives various types of data. Step S210 is equivalent to step S110 of Embodiment 1.

Object detection data is included in the various types of data.

The object detection data indicates a range in which the object that exists around the mobility vehicle 110 is detected. The object that exists around the mobility vehicle 110 is detected by the object detection sensor of the group of sensors 120.

In step S220, the bending angle calculation unit 221 calculates the bending angle of the route at the reference waypoint based on the route data.

Step S220 is a same as step S120 of Embodiment 1.

In step S230, the bending angle verification unit 222 compares the bending angle with the angle threshold.

Step S230 is a same as step S130 of Embodiment 1.

In step S240, the area tangent line setting unit 263 sets an area tangent line to be described later.

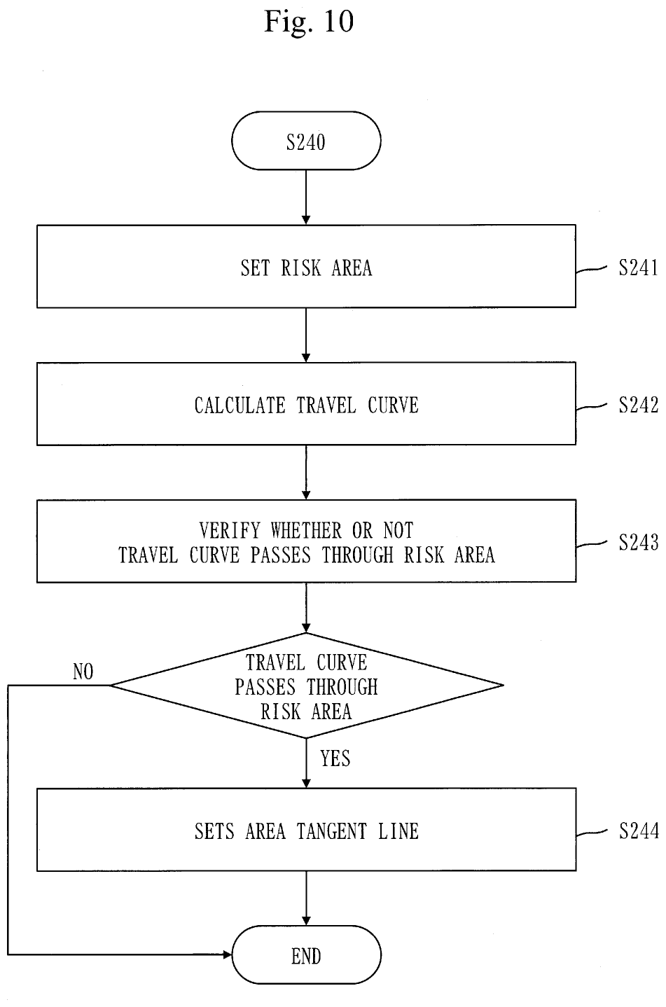

A procedure of step S240 will be described based on FIG. 10.

In step S241, the risk area setting unit 261 sets a risk area based on the object detection data.

The risk area is an area in which there is a risk of the mobility vehicle 110 colliding with the object.

Specifically, the risk area setting unit 261 calculates a midpoint of the object. Then the risk area setting unit 261 calculates an ellipse-shaped area having the midpoint of the object as a center, a length direction of the object as a direction of a major axis, and a normal direction to the length direction of the object as a direction of a minor axis. The area that is calculated is the risk area.

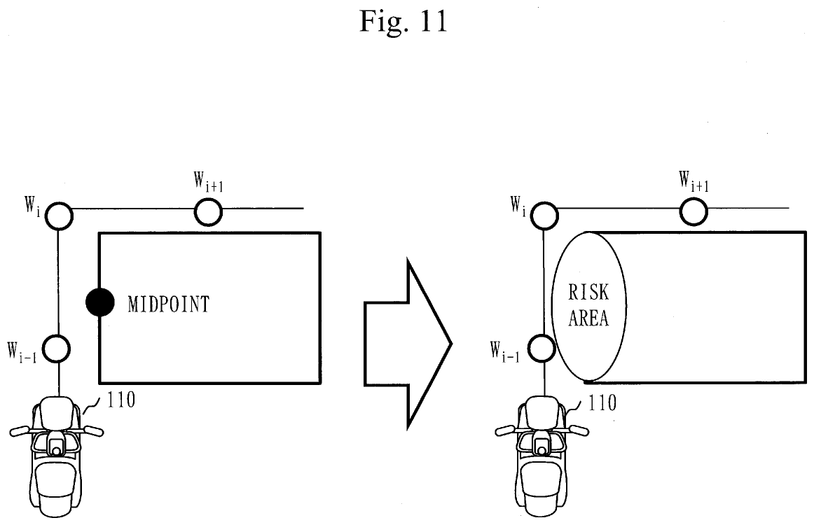

An example of the midpoint and the risk area is illustrated in FIG. 11.

In FIG. 11, a wall exists ahead of the mobility vehicle 110 on a right, and the object detection data indicates the wall that is detected. The wall is an example of the object.

The risk area setting unit 261 calculates the midpoint of the wall. Then the risk area setting unit 261 calculates as the risk area, the ellipse-shaped area having the midpoint as the center.

Returning to FIG. 10, the description will continue from step S242.

In step S242, the target position determination unit 230 calculates the travel curve of the mobility vehicle 110.

Step S242 is a same as step S141 of Embodiment 1.

In step S243, the risk area verification unit 262 verifies whether or not the travel curve passes through the risk area.

In a case where the travel curve passes through the risk area, the process proceeds to step S244.

In a case where the travel curve does not pass through the risk area, the area tangent line is not set, and the process ends.

In step S244, the area tangent line setting unit 263 sets the area tangent line based on the position of the mobility vehicle 110 and the risk area.

The area tangent line is a tangent line that passes through the position of the mobility vehicle 110 and touches the risk area.

Returning to FIG. 9, the description will continue from step S250.

In step S250, the target position determination unit 230 determines the target position based on the comparison result between the bending angle and the angle threshold.

Step S250 is equivalent to step S140 of Embodiment 1.

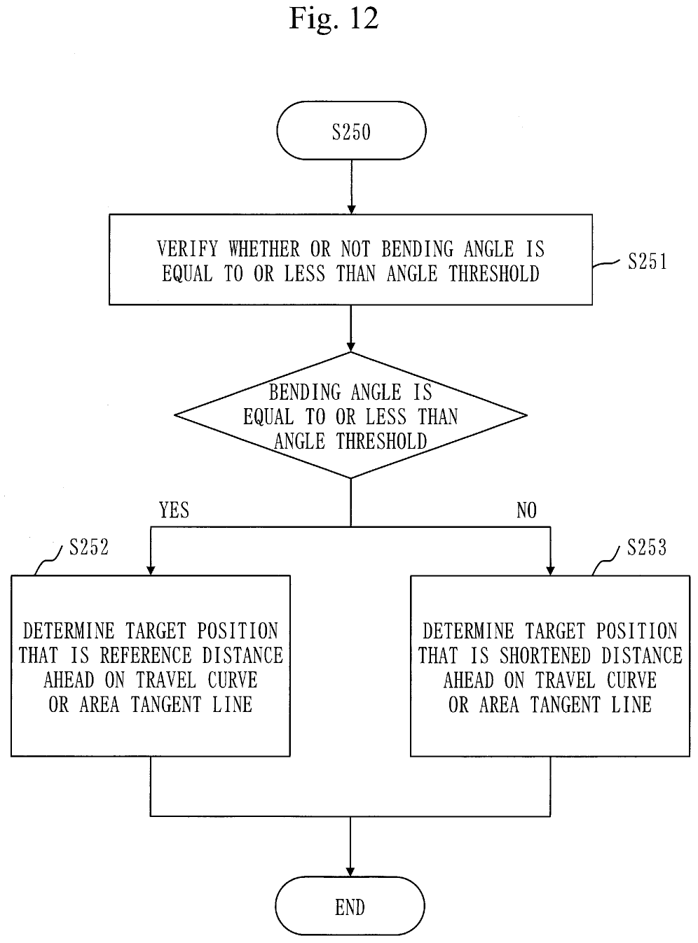

A procedure of step S250 will be described based on FIG. 12.

In step S251, the target position determination unit 230 verifies whether or not the bending angle is equal to or less than the angle threshold based on a comparison result of step S230.

In a case where the bending angle is equal to or less than the angle threshold, the process proceeds to step S252.

In a case where the bending angle is more than the angle threshold, the process proceeds to step S253.

In a case where the bending angle is equal to the angle threshold, however, the process may be made so that the process proceeds to step S253.

In step S252, the target position determination unit 230 determines the target position from the travel curve or the area tangent line.

Specifically, in a case where the area tangent line is not set, the target position determination unit 230 determines the target position from the travel curve. In a case where the area tangent line is set, the target position determination unit 230 determines the target position from the area tangent line.

The target position is a position that is the reference distance ahead of the position of the mobility vehicle 110.

In step S253, the target position determination unit 230 determines the target position from the travel curve or the area tangent line.

Specifically, in a case where the area tangent line is not set, the target position determination unit 230 determines the target position from the travel curve. In a case where the area tangent line is set, the target position determination unit 230 determines the target position from the area tangent line.

The target position is a position that is the shortened distance ahead of the position of the mobility vehicle 110.

Returning to FIG. 9, the description will continue from step S260.

In step S260, the travel speed determination unit 240 determines the travel speed based on the comparison result between the bending angle and the angle threshold.

Step S260 is a same as step S150 of Embodiment 1.

In step S270, the output unit 250 outputs the target position data and the travel speed data to the vehicle control device 130.

Step S270 is a same as step S160 of Embodiment 1.

### Effect of Embodiment 2

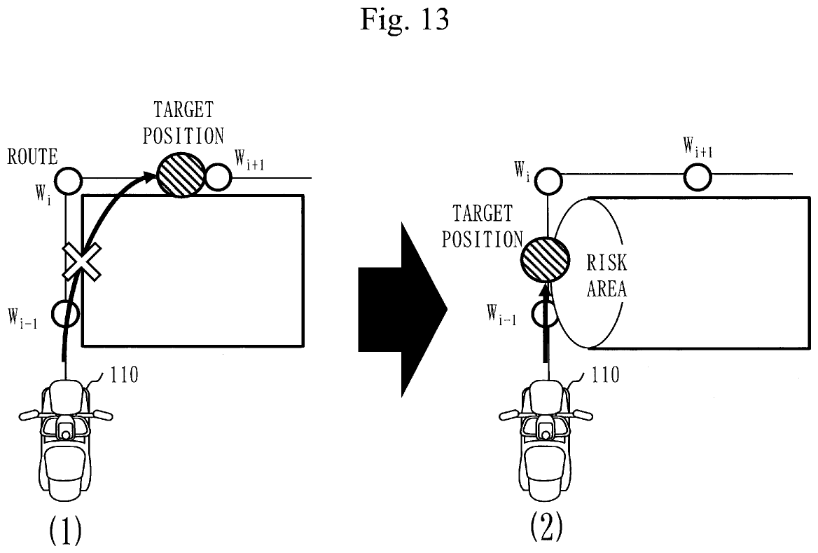

An effect of Embodiment 2 will be described based on FIG. 13.

(1) The bending angle at the reference waypoint (Wᵢ) of the route is a right angle. Consequently, the bending angle is large. The wall exists on an inner side of the route. In this case, when the target position is not near, the mobility vehicle 110 is to travel the curve that is significantly deviated inward from the route and collide into the wall.

(2) On the other hand, in Embodiment 2, in a case where the object such as the wall exists, the target position is set on the tangent line of the area in which there is a collision risk. As a result, avoiding the collision risk will be possible while securing an ability to follow the route.

### Embodiment 3

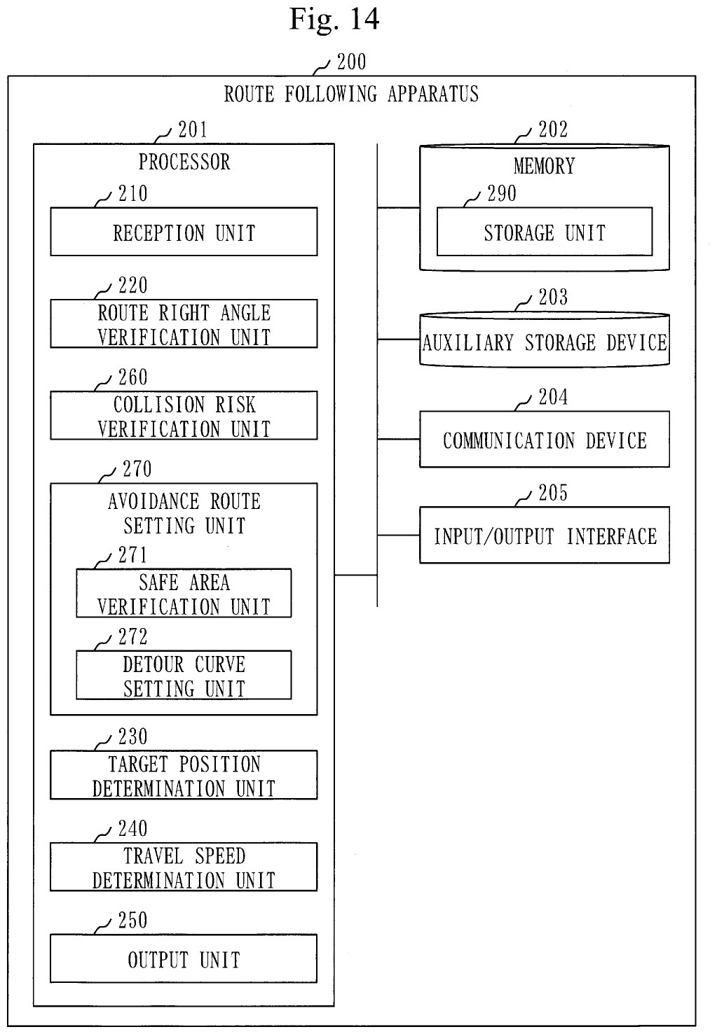

With regard to a form to avoid a collision with an object by detouring the route, mainly differing points from Embodiment 1 and Embodiment 2 will be described based on FIG. 14 to FIG. 19.

### Description of Configuration

A configuration of the mobility system 100 is a same as the configuration in Embodiment 1 (refer to FIG. 1).

A configuration of the route following apparatus 200 will be described based on FIG. 14.

The route following apparatus 200 further includes an avoidance route setting unit 270. The avoidance route setting unit 270 includes such elements as a safe area verification unit 271 and a detour curve setting unit 272.

The route following program further causes the computer to function as the avoidance route setting unit 270.

### Description of Operation

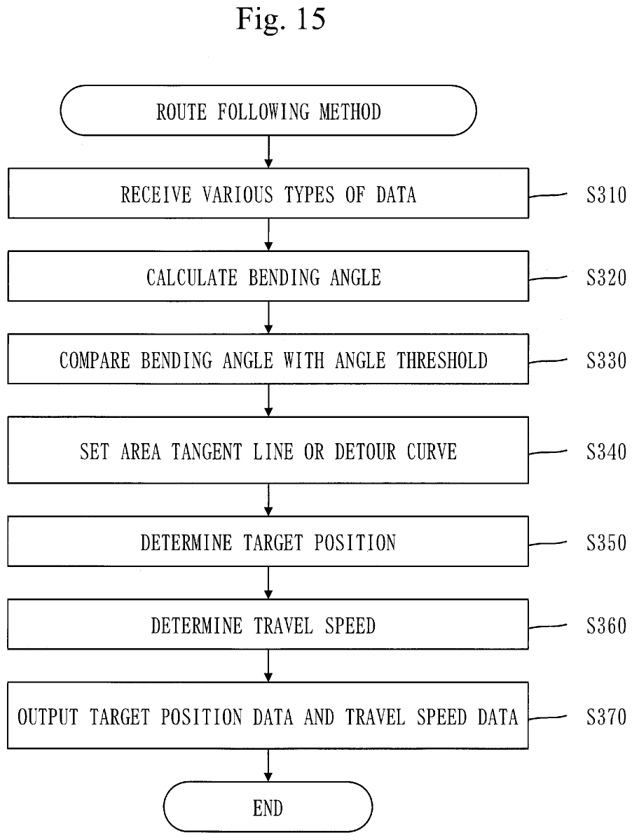

The route following method will be described based on FIG. 15.

In step S310, the reception unit 210 receives various types of data. Step S310 is equivalent to step S110 of Embodiment 1.

Safe area data is included in the various types of data.

The safe area data is data that indicates a safe area.

The safe area is an area in which the object is not detected.

In step S320, the bending angle calculation unit 221 calculates the bending angle of the route at the reference waypoint based on the route data.

Step S320 is a same as step S120 of Embodiment 1.

In step S330, the bending angle verification unit 222 compares the bending angle with the angle threshold.

Step S330 is a same as step S130 of Embodiment 1.

In step S340, the area tangent line setting unit 263 sets the area tangent line or a detour curve.

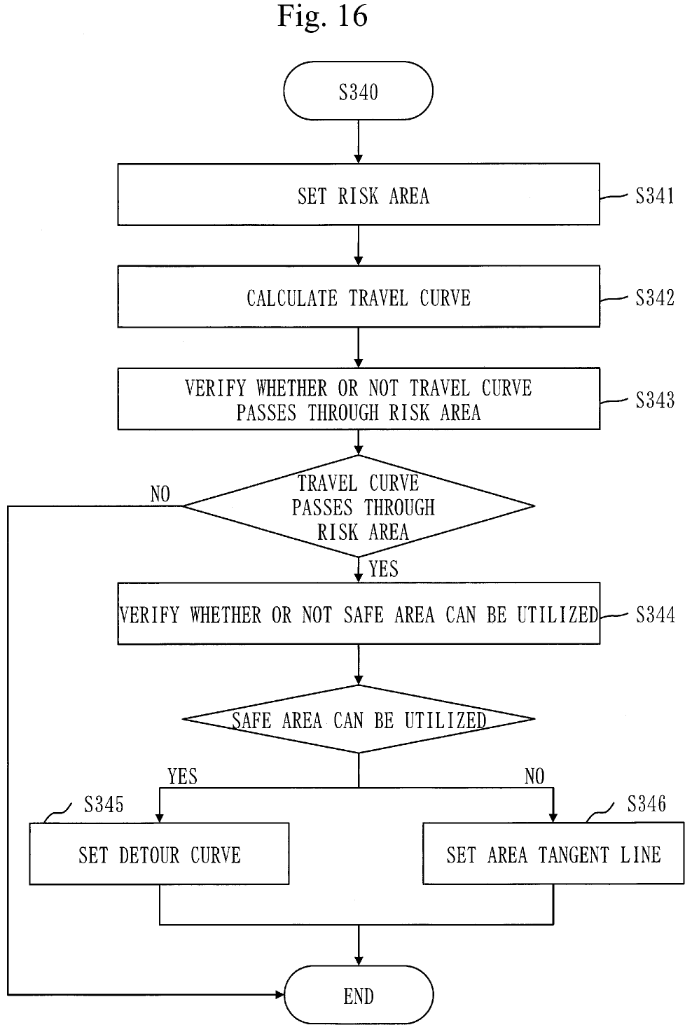

A procedure of step S340 will be described based on FIG. 16.

In step S341, the risk area setting unit 261 sets the risk area based on the object detection data.

Step S341 is a same as step S241 of Embodiment 2.

In step S342, the target position determination unit 230 calculates the travel curve of the mobility vehicle 110.

Step S342 is a same as step S141 of Embodiment 1.

In step S343, the risk area verification unit 262 verifies whether or not the travel curve passes through the risk area. Step S343 is equivalent to step S243 of Embodiment 2.

In a case where the travel curve passes through the risk area, the process proceeds to step S344.

In a case where the travel curve does not pass through the risk area, the area tangent line and a new waypoint is not set, and the process ends.

In step S344, the safe area verification unit 271 verifies whether or not a safe area can be utilized to avoid the risk area based on the safe area data.

Specifically, the safe area verification unit 271 verifies whether or not there is a safe area on an opposite side of the risk area, across the route to the reference waypoint. In a case where there is a safe area on the opposite side of the risk area, across the route to the reference waypoint, the safe area can be utilized to avoid the risk area.

In a case where the safe area can be utilized to avoid the risk area, the process proceeds to step S345.

In a case where the safe area cannot be utilized to avoid the risk area, the process proceeds to step S346.

In step S345, the detour curve setting unit 272 sets a representative point in the safe area and sets the detour curve.

The representative point is a point in the safe area. For example, the detour curve setting unit 272 sets an arc that passes through the reference waypoint and the safe area and that has a certain curvature, and sets the representative point on the arc set.

The detour curve is a cubic curve that passes through the position of the mobility vehicle 110, the representative point, and the reference waypoint.

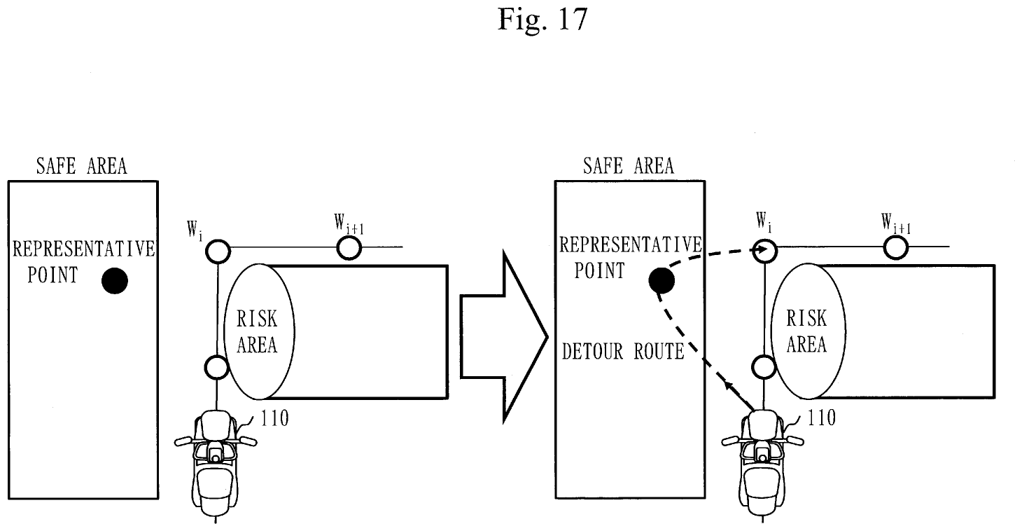

An example of the representative point and a detour route is illustrated in FIG. 17. A black circle represents the representative point, and a dashed line represents the detour route.

In FIG. 17, the safe area exists on the opposite side of the risk area, across the route to the reference waypoint (Wᵢ).

The detour curve setting unit 272 sets the representative point in the safe area. Then the detour curve setting unit 272 generates the detour route that passes through the representative point and the reference waypoint (Wᵢ).

Returning to FIG. 16, step S346 will be described.

In step S346, the area tangent line setting unit 263 sets the area tangent line based on the position of the mobility vehicle 110 and the risk area.

Step S346 is a same as step S244 of Embodiment 2.

Returning to FIG. 15, the description will continue from step S350.

In step S350, the target position determination unit 230 determines the target position based on the comparison result between the bending angle and the angle threshold.

Step S350 is equivalent to step S140 of Embodiment 1.

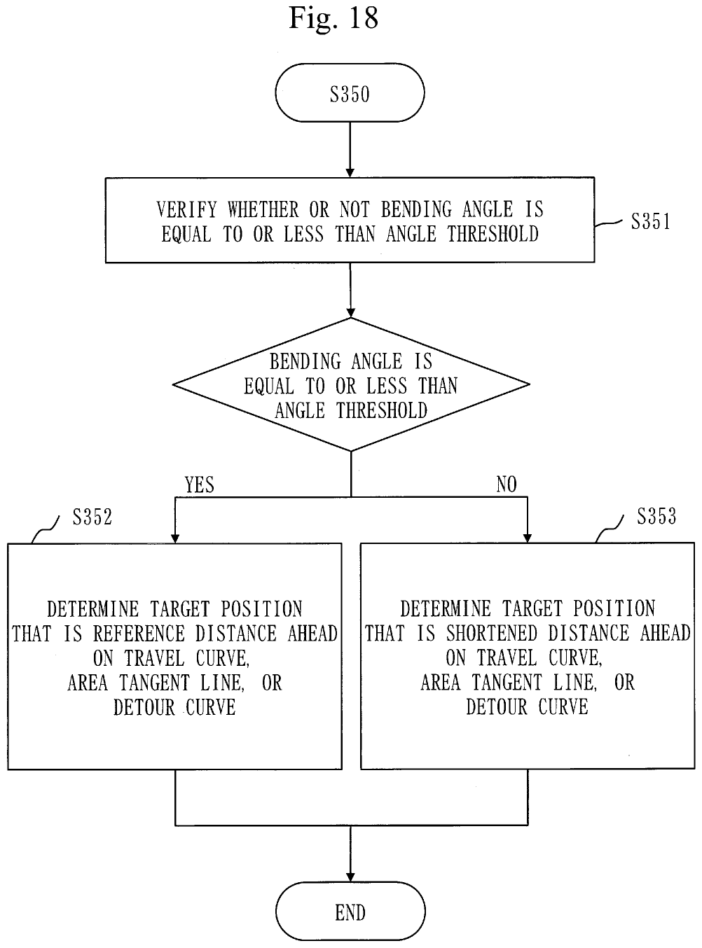

A procedure of step S350 will be described based on FIG. 18.

In step S351, the target position determination unit 230 verifies whether or not the bending angle is equal to or less than the angle threshold based on the comparison result of step S330.

In a case where the bending angle is equal to or less than the angle threshold, the process proceeds to step S352.

In a case where the bending angle is more than the angle threshold the process proceeds to step S353.

In a case where the bending angle is equal to the angle threshold, however, the process may be made so that the process proceeds to step S353.

In step S352, the target position determination unit 230 determines the target position from the travel curve, the area tangent line, or the detour curve.

Specifically, in a case where the area tangent line and the detour curve are not set, the target position determination unit 230 determines the target position from the travel curve. In a case where the area tangent line is set and the detour curve is not set, the target position determination unit 230 determines the target position from the area tangent line. In a case where the detour curve is set, the target position determination unit 230 determines the target position from the detour curve.

The target position is a position that is the reference distance ahead of the position of the mobility vehicle 110.

In step S353, the target position determination unit 230 determines the target position from the travel curve, the area tangent line, or the detour curve.

Specifically, in a case where the area tangent line and the detour curve are not set, the target position determination unit 230 determines the target position from the travel curve. In a case where the area tangent line is set and the detour curve is not set, the target position determination unit 230 determines the target position from the area tangent line. In a case where the detour curve is set, the target position determination unit 230 determines the target position from the detour curve.

The target position is a position that is the shortened distance ahead of the position of the mobility vehicle 110.

Returning to FIG. 15, the description will continue from step S360.

In step S360, the travel speed determination unit 240 determines the travel speed based on the comparison result between the bending angle and the angle threshold.

Step S360 is a same as step S150 of Embodiment 1.

In step S370, the output unit 250 outputs the target position data and the travel speed data to the vehicle control device 130.

Step S370 is a same as step S160 of Embodiment 1.

### Effects of Embodiment 3

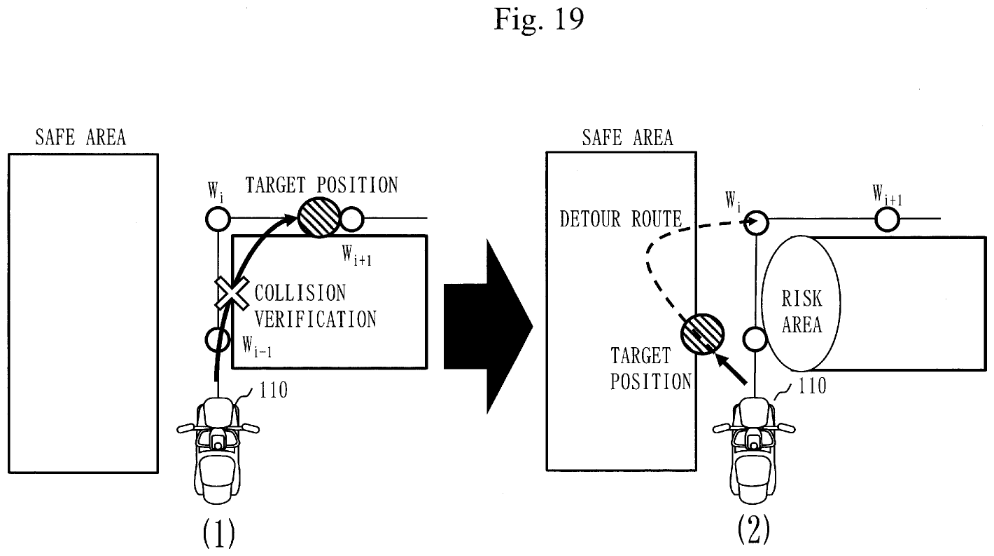

Effects of Embodiment 3 will be described based on FIG. 19.

(1) The bending angle at the reference waypoint (Wᵢ) of the route is a right angle. Consequently, the bending angle is large. The wall exists on the inner side of the route. In this case, when the target position is not near, the mobility vehicle 110 is to travel the curve that is significantly deviated inward from the route and collide into the wall.

(2) The safe area to where the mobility vehicle 110 is possible to be caused to detour exists. In Embodiment 3, the detour route to pass the safe area in a case where the safe area exists is set. As a result, a collision with the object can be more reliably avoided. Since the detour route is a gentle route where the mobility vehicle 110 does not take a sharp turn, the riding comfort of the mobility vehicle 110 is maintained.

### Supplement to Embodiments

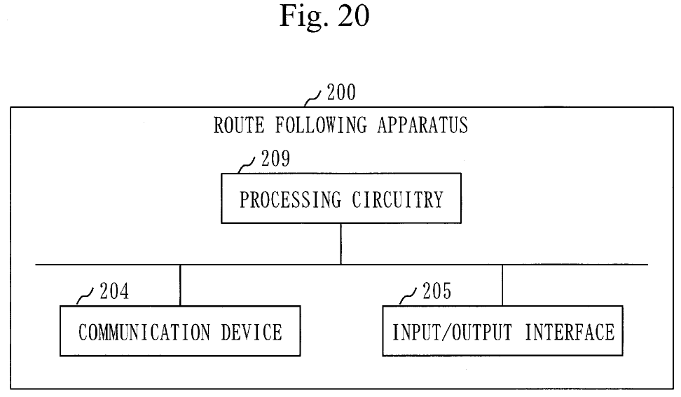

A hardware configuration of the route following apparatus 200 will be described based on FIG. 20.

The route following apparatus 200 includes processing circuitry 209.

The processing circuitry 209 is hardware that realizes the reception unit 210, the route right angle verification unit 220, the target position determination unit 230, the travel speed determination unit 240, the output unit 250, the collision risk verification unit 260, and the avoidance route setting unit 270.

The processing circuitry 209 may be dedicated hardware or may be the processor 201 that executes a program stored in the memory 202.

In a case where the processing circuitry 209 is dedicated hardware, the processing circuitry 209, for example, is a single circuit, a composite circuit, a programmed processor, a parallel programmed processor, an ASIC, an FPGA, or a combination of these.

ASIC is an abbreviated name for Application Specific Integrated Circuit.

FPGA is an abbreviated name for Field Programmable Gate Array.

The route following apparatus 200 may include a plurality of processing circuits that replace the processing circuitry 209.

In the processing circuitry 209, a part of functions may be realized by dedicated hardware and the rest of the functions may be realized by software or firmware.

As described, functions of the route following apparatus 200 can be realized by hardware, software, firmware, or a combination of these.

Each embodiment is exemplification of a preferred mode, and is not intended to limit the technical scope of the present disclosure. Each embodiment may be carried out partially or may be carried out being combined with a different mode. The procedures described using the flowcharts and the like may be changed as appropriate.

“Unit”, which is an element of the route following apparatus 200 may be replaced with “process”, “step”, “circuit”, or “circuitry”.

### REFERENCE SIGNS LIST

100: mobility system; 110: mobility vehicle; 120: group of sensors; 130: vehicle control device; 140: vehicle; 200: route following apparatus; 201: processor; 202: memory; 203: auxiliary storage device; 204: communication device; 205: input/output interface; 209: processing circuitry; 210: reception unit; 220: route right angle verification unit; 221: bending angle calculation unit; 222: bending angle verification unit; 230: target position determination unit; 240: travel speed determination unit; 250: output unit; 260: collision risk verification unit; 261: risk area setting unit; 262: risk area verification unit; 263: area tangent line setting unit; 270: avoidance route setting unit; 271: safe area verification unit; 272: detour curve setting unit; 290: storage unit.

1. A route following apparatus comprising:
processing circuitry to:
calculate a bending angle of a route at a reference waypoint, the reference waypoint being (the number of reference points)th waypoint toward a goal point from a position of a mobility vehicle, based on route data that indicates a plurality of waypoints positioned on the route to the goal point,
compare the bending angle with an angle threshold,
determine a position that is a reference distance ahead of the position of the mobility vehicle as a target position that is to be a next destination of the mobility vehicle in a case where the bending angle is less than the angle threshold, and determine a position that is a shortened distance ahead of the position of the mobility vehicle as the target position, the shortened distance being shorter than the reference distance, in a case where the bending angle is more than the angle threshold,
set a risk area in which there is a risk of the mobility vehicle colliding with an object based on object detection data that indicates a range in which the object that exists around the mobility vehicle is detected,
verify whether or not a travel curve along the route before and after the reference waypoint passes through the risk area, and
set an area tangent line that passes through the position of the mobility vehicle and touches the risk area in a case where the travel curve passes through the risk area, wherein
the processing circuitry
determines the target position from the area tangent line in a case where the area tangent line is set.

2. The route following apparatus according to claim 1, wherein
the processing circuitry
obtains from the route data, a coordinate value of the reference waypoint, a coordinate value of a preceding waypoint positioned preceding the reference waypoint, and a coordinate value of an ahead waypoint positioned ahead of the reference waypoint, and calculates the bending angle based on the coordinate values obtained.

3. The route following apparatus according to claim 1, wherein
the processing circuitry
sets as the risk area, an ellipse-shaped area having a midpoint of the object as a center, a length direction of the object as a direction of a major axis, and a normal direction to the length direction of the object as a direction of a minor axis.

4. The route following apparatus according to claim 1, wherein
the processing circuitry
verifies whether or not a safe area can be utilized to avoid the risk area based on safe area data that indicates the safe area in which the object is not detected in a case where the travel curve passes through the risk area,
sets a detour curve that passes through the position of the mobility vehicle, a representative point in the safe area, and the reference waypoint in a case where the safe area can be utilized to avoid the risk area, and
determines the target position from the detour curve in a case where the detour curve is set.

5. A route following method comprising:
calculating a bending angle of a route at a reference waypoint, the reference waypoint being (the number of reference points)th waypoint toward a goal point from a position of a mobility vehicle, based on route data that indicates a plurality of waypoints positioned on the route to the goal point;
comparing the bending angle with an angle threshold;
determining a position that is a reference distance ahead of the position of the mobility vehicle as a target position that is to be a next destination of the mobility vehicle in a case where the bending angle is less than the angle threshold, and determining a position that is a shortened distance ahead of the position of the mobility vehicle as the target position, the shortened distance being shorter than the reference distance, in a case where the bending angle is more than the angle threshold;
setting a risk area in which there is a risk of the mobility vehicle colliding with an object based on object detection data that indicates a range in which the object that exists around the mobility vehicle is detected;
verifying whether or not a travel curve along the route before and after the reference waypoint passes through the risk area; and
setting an area tangent line that passes through the position of the mobility vehicle and touches the risk area in a case where the travel curve passes through the risk area, wherein
the target position is determined from the area tangent line in a case where the area tangent line is set.

6. A non-transitory computer readable medium storing a route following program for causing a computer to execute:
a bending angle calculation process to calculate a bending angle of a route at a reference waypoint, the reference waypoint being (the number of reference points)th waypoint toward a goal point from a position of a mobility vehicle, based on route data that indicates a plurality of waypoints positioned on the route to the goal point;
a bending angle verification process to compare the bending angle with an angle threshold;
a target position determination process to determine a position that is a reference distance ahead of the position of the mobility vehicle as a target position that is to be a next destination of the mobility vehicle in a case where the bending angle is less than the angle threshold, and to determine a position that is a shortened distance ahead of the position of the mobility vehicle as the target position, the shortened distance being shorter than the reference distance, in a case where the bending angle is more than the angle threshold;
a risk area setting process to set a risk area in which there is a risk of the mobility vehicle colliding with an object based on object detection data that indicates a range in which the object that exists around the mobility vehicle is detected;
a risk area verification process to verify whether or not a travel curve along the route before and after the reference waypoint passes through the risk area; and
an area tangent line setting process to set an area tangent line that passes through the position of the mobility vehicle and touches the risk area in a case where the travel curve passes through the risk area, wherein
the target position determination process determines the target position from the area tangent line in a case where the area tangent line is set.

7. The route following apparatus according to claim 2, wherein
the processing circuitry
sets as the risk area, an ellipse-shaped area having a midpoint of the object as a center, a length direction of the object as a direction of a major axis, and a normal direction to the length direction of the object as a direction of a minor axis.

8. The route following apparatus according to claim 2, wherein
the processing circuitry
verifies whether or not a safe area can be utilized to avoid the risk area based on safe area data that indicates the safe area in which the object is not detected in a case where the travel curve passes through the risk area,
sets a detour curve that passes through the position of the mobility vehicle, a representative point in the safe area, and the reference waypoint in a case where the safe area can be utilized to avoid the risk area, and
determines the target position from the detour curve in a case where the detour curve is set.

9. The route following apparatus according to claim 3, wherein
the processing circuitry
verifies whether or not a safe area can be utilized to avoid the risk area based on safe area data that indicates the safe area in which the object is not detected in a case where the travel curve passes through the risk area,
sets a detour curve that passes through the position of the mobility vehicle, a representative point in the safe area, and the reference waypoint in a case where the safe area can be utilized to avoid the risk area, and
determines the target position from the detour curve in a case where the detour curve is set.
